(19) United States
(12) Patent Application Publication
(10) Pub. No.: US 2014/0222592 A1
(43) Pub. Date: Aug. 7, 2014

(54) METHOD AND SYSTEM OF INTERNET CONNECTED COMPUTERS FOR ORGANIZING GLOBALLY PRESENTED ORIGINAL DATA IN THE WORLD WIDE WEB LOCALLY

(71) Applicant: HANS DIEDRICH KREFT, Dassendorf (DE)

(72) Inventor: HANS DIEDRICH KREFT, Dassendorf (DE)

(73) Assignee: shuccle AG, Dassendorf (DE)

(21) Appl. No.: 14/167,084

(22) Filed: Jan. 29, 2014

Related U.S. Application Data
(60) Provisional application No. 61/758,068, filed on Jan. 29, 2013.

(51) Int. Cl. G06Q 30/02

(52) U.S. Cl. CPC G06Q 30/0277
USPC 705/14.73

(57) ABSTRACT

A method and system of internet connected computers for organizing globally presented original data in the World Wide Web locally. This data mainly consists of human generated data (websites, text files etc.) and also automatically produced technical data (from sensors, machines, chip cards etc.). The present invention describes how humans can assign metadata to the original data to describe specific aspects of the original data content. The system for creating and organizing web content through metadata is called Web Operating System (WOS). The software that controls the WOS is contained in the Web Operation Kernel (WOK). A WOK is standardized software that can be loaded on local servers or on individual computers (PCs) locally. The local WOK is controlled by users through tools on a graphic user interface (GUI) via a web-browser. This metadata, generated by human intelligence, is stored on local servers which host the WOK.

### TECHNICAL FIELD

The present invention relates to a method and system of interconnected computers for organizing data in the web by human created metadata.

### BACKGROUND OF THE INVENTION

Problem Statement

With the explosion of the internet since the mid-nineties, the number of active websites in the World Wide Web has increased to over half a billion today. The challenge of navigating this vast amount of data manually has since given rise to automated search engines. A search engine helps a user to find content in the web through software algorithms that sort and return search results to the user. Since the search results are derived by computer software, they are a search engine's best guess of what the user is searching for. This oftentimes results in inapplicable search results being returned. More specifically, by entering keywords into the search engine, the user is able to search for any word in any webpage. The longer the list of connected keywords, the more difficult it is for the search engine to return results for the intended search. That is, the search engine is able to search for individual and connected keywords but not for the meaning that arises by connecting certain words in a particular context.

Another related problem is the difficultly of processing data in a timely fashion. Search engines use web crawlers that browse the web and create a copy of specific data of the webpages they visit. These specific data are indexed and combined with the URL of the webpages and later used as a database (repository) for searches. As a result, a search engine's presented content in the web is time delayed and not live. More specifically, conventional search engines are unable to detect altered content on individual webpages due to technical restraints. For a search engine to detect content that was altered since the last crawler visit it would have to compare the complete content of a web site previously saved with the present content. This process will exorbitantly exceed the technical possibilities of today's IT-Systems.

Search engines are also not suitable for searching technical devices (sensors, machines, chip cards etc.) and their automatically generated data directly. More specifically, to date, no universal system or method that allows for direct communication between web users and technical devices through a web browser exists. As of present, automatically generated data from technical devices can only be accessed indirectly via an intermediate interface, commonly a website. If the website is down, the technical device cannot be accessed. Furthermore, if the data from multiple sensors is presented on different websites, a user has to employ specifically customized software capable of communicating with the different websites to retrieve data from various sensors concurrently.

The above issues illustrate that there is a lack of a universal system for organizing content in the web that meets web user needs. To address this issue, mainly two distinct solution attempts have been suggested. One is presented by a collaborative movement (the Dublin Core Metadata Initiative: DCMI) led by the main international is standards organization for the world wide web, the World Wide Web Consortium (W3C). The other follows the intention of the market main players (Google, Amazon, Microsoft, Apple etc.) to compile personal data of web users. This data is used to present web content that best corresponds to the stored user data.

The aim of the DCMI is to organize data in a semantic web in which data is classified in topic categories and described by a standard based on a common framework. The DCMI literature became the de facto standard used for the discussion of how content could be categorized by metadata through computer intelligence. However, to date, no feasible mechanism for implementing the concept of semantically organizing data in the web on a universal and suitable scale exists in the market.

Alternatively the market main players assemble user profiles (personal data and behavior of Web-Users) on a large scale to present content which relates to the assembled data. For example: A user of a service is recognized by their stored data and is presented with the specific service that fits to their data.

Both attempts rely on computer processes to organize and decide what data to present to a user. The ever increasing data to be organized and analyzed is reaching the limitations of the data servers processing power. As a result the Apache Hadoop framework has been developed and become the de facto standard to alleviate the problem of processing big data. The Hadoop framework allows distributed data processing across computer clusters by dividing data processing between different nodes within the cluster while the main or name node oversees the processing of the independent nodes.

However, both attempts (categorization, user profiles) are not based on the specific human ability to describe content by metadata. If, for example, a person is describing an object another person is looking to find and where it may be found, they will use metadata to describe the non-visible object. Similarly, the same case can be made for a supplier of a specific product or service. The product or service supplier describes their product or service by its metadata in the web. The potential customer interprets the metadata and decides whether or not to respond to the offering. Both example show that humans interact informal and are able to optimize that interaction by improving their metadata (describing their intention). If, as in the first case, the object is not found, both parties will communicate and continually adapt the metadata until the second person is able to find the object. Similarly, if, in the second case of the product/service supplier, no customer is willing to engage the offer, the supplier will adapt the metadata to more fittingly describe their offering. In short, human communication relies on a strong interrelationship between the human intelligence of individuals which is not reflected in present methods used for organizing and finding content in the web.

By use of human generated metadata, the present invention resolves the above mentioned issue.

### SOLUTION TO THE PROBLEM

The present invention provides a system and method for organizing web-content by use of human intelligence. Data in the web is organized by method of a universal Web Operating System called WOS which is controlled by software called, Web Operating Kernel (WOK), that is in turn controlled by users through a graphic user interface (GUI). The GUI is displayed in a web browser window by a client system such as a personal computer, tablet PC, smartphone etc.. The unique WOK is loaded to locale servers which are interconnected through the Internet. Through the WOK's GUI, users can categorize content under given umbrella topics, and assign metadata to it to facilitate data navigation. The metadata may include a title, a description, keywords and link addresses. The metadata are stored on the local servers that also host the WOK. To facilitate the system communication, each server and its WOK are assigned a unique identifier such as an IP (Internet Protocol) addresses. As such, they are identifiable and accessible in real time by all other servers containing the WOK. Original content, weather generated by humans or automatically by technical devices, such as sensors, devices, chip cards, organized by human users, can now be searched and found live through the WOS infrastructure. This is done by inputting keywords via the GUI of the WOK that are matched to the metadata assigned to the original content. Since new content or changes to existing content made by users is made available to the web-infrastructure through the WOK instantaneously, all content accessed through the WOS infrastructure is up to date and live. This enables real time searching for content by foregoing the intermediate process of a conventional search engine.

The method and system is analogous to a shopkeeper's shop-window to showcase products, in which the shop-window represents the WOK and the products are represented by metadata. A shopkeeper will display a sample of the products sold in the store to attract customers into the store. To attract many customers into the store, the shopkeeper will rely on the basic market principles of demand and supply and only choose to display those products that are demanded by the customers and thus attract the most customers to the store. Similarly, the user of the present invention will supply metadata, which are made available to other users of the WOS based infrastructure through the WOK that attract the largest number of their intended audience to their original content. Like the shopkeeper, who can continuously change the product in the window to adjust to customer responses, users (suppliers of content) can repeatedly alter the metadata in response to the audience's demand. In the above mentioned case the degree of success is solely dependent on human intelligence while the artificial intelligence in form of software is only used for optimizing the human intentions and aiding in organizing content and metadata.

### SUMMARY OF THE INVENTION

The present invention provides a method and device for establishing an infrastructure in the internet for providing and organizing technical and human generated data which are presented as Web-Content and accessible by WEB-Methods. An embodiment of the present invention provides a Web-Operation-Kernel (WOK) consisting of a software and data memory which may both be loaded on different local servers. The software supports common programming languages like PHP; Ruby etc. to communicate with the servers. The memory conforms to a data bank system capable of providing multi user access managed through programming language like MySQL. Each local server hosting a WOK connected to the internet is uniquely identifiable through its internet addresses to facilitate system communication. All individual WOKs contain a list of the internet addresses of all WOK hosting servers connected to the infrastructure. If a new server hosting a WOK is connected to the system, the list is automatically updated. Besides the WOK hosting server's known internet address, each individual WOK is also assigned a unique identifier which may consist of a specific name, number, IP address, graphic or symbol. Because all WOKs know and can uniquely identify all other WOKs and their host servers, through their Internet address and unique identifiers, the WOKs can directly exchange WOK-Data between each other. This WOK data contains metadata that is structured into different classes for describing technical or human generated data to facilitate data navigation. One of the above mentioned classes can be used to present advertising data. The WOK data and the tools to control it are presented in a WOK-Window in a web browser window. As such, each individual WOK and its WOK-Data can be controlled by accessing the WOK hosting server through its known unique internet address through a web browser. In turn, additions or changes made to WOK-Data on any individual WOK will be accessible by all other WOKs instantaneously.

Each of the WOK is located on a specific server hardware in a server farm environment. Server farms consist of multiple single server hardware which are connected to each other by specific busses. They are hosted in specially prepared rooms or buildings. Each hardware stores all the Web-Content of one or more webpage owners. It is only necessary for the WOK to be loaded on one such server hardware in a server farm from which it and its WOK Window can be accessed from all other servers.

The original main WOK is hosted on a central server from which it can be loaded to other local servers. In one embodiment of the present invention, one WOK constitutes the original main WOK on which all other remote WOKs depend. The main WOK will communicate any changes to all other WOKs in the infrastructure. A copy of the main WOK can be loaded on other local servers. The main WOK may assemble or acquire data from all local WOKs and extract specific data from them. This data may be sent back and distributed to some or all local WOKs. As such the main WOK establishes a new infrastructure with the remote WOKs.

In one embodiment of the present invention each individual WOK on the different local servers is assigned a unique identifier which may consist of a specific name, number, graphic or symbol or IP address to facilitate system communication. The WOKs can directly communicate with each other through their unique identifiers.

In another embodiment of the present invention, the memory containing the WOK-Data is organized by a database structured to contain different classes of metadata. These classes aid in data navigation and may, for example, include topics, description, keywords, link addresses, graphics, symbols and advertisement data. As such, Web-Content is categorized by topics. The topics may consist of one word ore a short line of text. The description outlines the content and may consist of some short lines of text while the keywords act as anchor terms to identify the content and aid in finding it when searched for. The link addresses link the metadata to the original content. The metadata may include symbols or graphics such as pictures to represent content. One of the metadata classes is utilized for presenting advertising data. The structured database itself may be utilized by technical systems for optimizing search algorithm.

In one embodiment of the present invention, the memory of the WOK is structured into pre-defined topic groups under which the metadata and their referenced Web-Content are categorized. These categorical groups are organized in topic groups which specify aspects of the metadata. Each topic group defines a category of Web-Content by its original name. For example, the topic group “Finance” defines all Web-Content that users relate to it. These topic groups are managed through the original main WOK which then synchronously communicates the information to all other WOKs on the local servers, ensuring a uniform system for classifying web content on each local server by identical topic groups. This categorization into topic groups includes tagging content and its metadata to umbrella topics. A content provider may, for instance, provide content relevant to the “Finance” category. If a WOK-User is searching for a new credit card supplier, they may look for content related to the “Finance” category. The user will find a list of all credit card providers who assembled their data in this category. More particularly, human intelligence of both the supply as well as the demand side governs the organization of content into the appropriate categories.

In an embodiment of the present invention, the WOK Window is presented in a browser window which displays the WOK-Data and tools to control and search this data presented in a graphic user interface (GUI).

Another embodiment of the present invention provides means for inputting search terms in the WOK-Window and initiating a search for content through the GUI. A content search initiates a query, a request for data, to instantaneously find matching metadata categorized by the corresponding topic groups on all WOKs within the infrastructure. Content and its metadata matching the data request are returned and displayed in the WOK-Window the user initiated the search in.

One embodiment of the present invention includes the means for inputting a search term and specific topic group in two separate windows in the WOK Window's GUI. More particularly, the user may specify if they search a category of topics, specific keywords within all topic categories or keywords within a specific category, i.e. topic group. A dynamic visual effect between the topic category input window and the keyword input window appears and indicates that a specific relation between both exist. If, for example, a user searches for the content that pertains to lawnmowers and also selects the categorical topic group “gardening” to narrow their search, the search combination may be visualized graphically by a movement of the input windows in the GUI of the WOK Window. In an other implementation the graphical effect may, for example, include that the topic category input window and the keyword input window will adapt the same color if content relating to the keyword within the selected topic category was found via matching metadata. If, in contrast, only a keyword search or, alternatively, only a topic category (i.e. topic group) search is selected, the respective windows may, for example, adapt differing color schemes.

One embodiment of the present invention provides means for users to provide and upload content that is saved on the servers hosting the local WOKs. This content includes webpages and blogs. The content is categorized by topic groups and described with metadata like any other human or technically generated data. The blog, website or any other file a user may provide is thus searchable by the same methods within the WOK based infrastructure as any other data that is described by metadata.

In one embodiment of the present invention, the GUI contains advertisement areas that can be rented out to third party advertisers. Content providers may individually rent out this advertisement space. Since the advertisement data is part of the metadata and thus matched with the original content, other users who search for corresponding content are presented with the advertisements matched to the metadata. The sale of advertisement space thus follows the franchise principle. Content providers themselves thus become franchisees and directly participate in the revenue generated through the advertisements. The more popular the content and the more users search for it, the higher the demand for the corresponding advertisement space. Successful content providers can thus auction off their advertisement space for higher fees. More particularly, the method of the present invention recognizes the success of the content provider's submissions by distributing the revenue generated through advertisements corresponding to the provided content with the content provider. In contrast, conventional search engine models do not include the content provider in its advertisement revenue allocation but wholly absorb the revenue from advertisements.

In one embodiment of the present invention, the WOK Infrastructure includes technical data. This data is generated by Local Data Generating Devices. In an embodiment of the present invention this data is instantaneously presented via the internet to multiple requesters concurrently.

The Local Data Generating Device contains the components Memory-Meta-Data, Local is Data Capture and Interface. The interface in turn contains a Priority Sequencing component as well as an Internet connection.

The Memory-Meta-Data component contains the metadata describing the Local Data Generating Device itself and its data. After the device has been initialized with the WOK infrastructure, similar to any other metadata, this metadata may be inputted and altered by human users through the WOK Window. The initialization process may require inputting a manufacturer generated code as may be found in the device's manual. This ensures that no users can alter the metadata unauthorized.

In one embodiment of the present invention, each Memory-Meta-Data contains inerasable data that uniquely identifies the Local Data Generating Device. It is thus ensured that individual Local Data Generating Device can unambiguously be identified and found.

The Local Data Capture component constitutes the technical device which produces the technical data. This may include sensors that directly produce the technical data but may include devices within the technical device capable of producing data generated either by software or hardware components.

In another embodiment of the present invention the Local Data Capture component may contain one or more ports for exchanging data with externally connected devices. More specifically, these external devices may include technical devices that lack the capability to autonomously transmit technical data to a WOK via the internet.

In one embodiment of the present invention, the Local Data Generating Device contains a Memory Stack component and Sequenced Data component.

The Memory Stack constitutes a partitioned memory in which partitions are assigned to individual users currently requesting data from a Local Data Generating Device. More specifically, such user requests follow unforeseeable behavior which results in a stochastic (random) appearance of the requests. Users may, for example, request data in varying time intervals. Furthermore, because users may request varying data sets, the time for a data transfer from the device to the user may vary. Additionally, if too many users concurrently request data, the bandwidth capacity may be exhausted and data transfers will collapse. In one embodiment of the present invention individual data requested by a user is therefore intermittently stored in a memory stack partition assigned to the user before it is transmitted to the requesting user. It is thus ensured that each individual user receives a complete set of the technical produced data.

In one embodiment of the present invention the port for exchanging data with externally connected devices is equipped to accept data from transportable data devices. Transportable data devices include USB sticks, keys, chip cards, etc.. More particularly, the port may feature slots to accept USB sticks or chip cards through which the externally connected device can communicate with the WOK infrastructure. A coffee machine may, for instance, be equipped with a slot to accept chip cards in which a user inserts their card to purchase coffee. The chip card utilizes the external port to exchange the purchase data with the WOK infrastructure where the purchase information is stored on the card itself and also communicated to the WOK infrastructure.

### BRIEF DESCRIPTION OF THE DRAWINGS

FIG. 1 contrasts the method of operation of present search engine models with the search and find concept of the present invention

FIG. 2 illustrates an example infrastructure to organize content in the web in one embodiment of the invention

FIG. 3 illustrates how metadata are presented in a WOK Window in one embodiment of the present invention

FIG. 4-15 illustrate the use and operation of an example universal operating system software to organize data in the web in one embodiment of the present invention.

FIGS. 16, 17 are example flow diagrams of data from a technical device to the individual user through priority sequencing.

### DETAILED DESCRIPTOIN OF THE INVENTION

FIG. 1 contrasts the method of operation of present search engine models with the search and find concept of the present invention, demonstrating one fundamental aspect of the present invention. The top part of Figure X illustrates how conventional search engines operate. The search engine 101 receives a request for data from Server A 102. The search engine software matches the request with items in its repository on Server B 103 and returns the results. In contrast, as illustrated in the lower part of FIG. 1. Both servers A, B 104, 105 uniquely identify each other through the software integrated in the WOKs. More specifically, since the software contained in each WOK contains a list of the unique identifiers, such as the IP-Addresses, of all presently connected local WOKs, each local WOK can directly communicate with all other WOKs. Users residing on servers with a WOK can populate its database memory with their metadata for describing their original content. If WOK-Window 106 sends a request via the internet 107 for specific metadata, all other WOK-Windows will receive it and respond. Furthermore, any changes to data through a local WOK are presented by its WOK-Window instantaneously and live without time delay. More particularly, changes to content or metadata made on Server B 104, are immediately presented to the WOK infrastructure and are visible to Server A 105 through the WOK Window 108. The search and find method of the conventional search engine is thus obsolete.

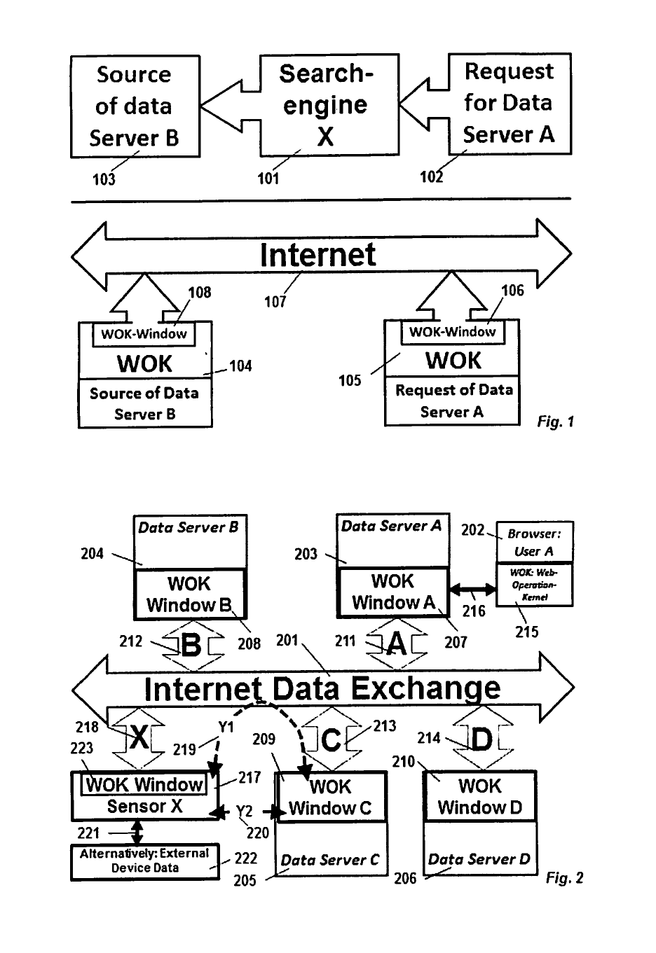

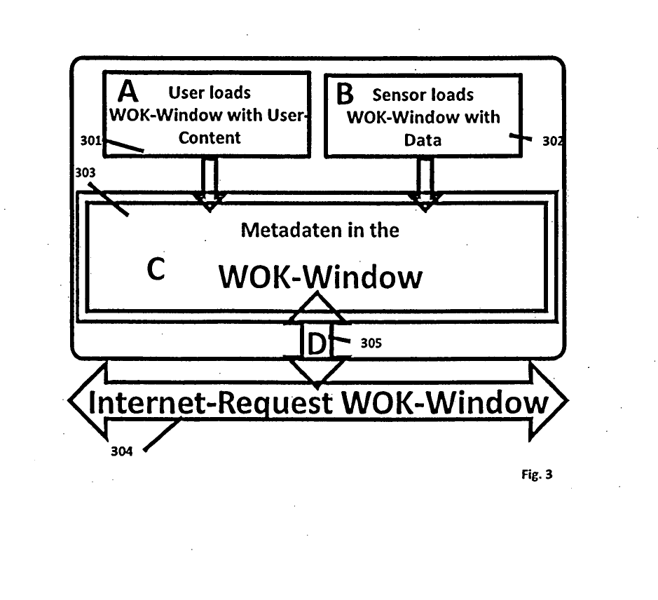

A general overview of a preferred embodiment of the present invention is illustrated in FIG. 2. It represents an example infrastructure to organize content in the web by human intelligence through a universal operating system software, called Web Operating Kernel (WOK). Local Data Servers A 203, B 204, C 205, D 206 are connected with the Internet 201 through connection A 211, B 212, C 213 and D 214 using conventional IT protocols (HTTP, TCP/IP etc.). Each local server hosts a copy of the WOK capable of displaying data in the respective WOK Windows; A 207, B 208, C 209, D 210. While the original content is located on local servers, the WOK Windows displays the metadata identifying the corresponding original content stored. (i.e. FIG. 3). Because each server hosting the WOK is registered within the infrastructure and uniquely identifiable through the host server's IP address, data contained on the servers within the WOS infrastructure are accessible in real time by all other servers that host the WOK.

FIG. 2. furthermore illustrates how, as in an embodiment of the present invention, user A 202 searches content contained on a server unknown to the user within the WOK infrastructure. Through the WOK's GUI 215 presented in the user's web browser window, user A inputs a search phrase (universal topics, keywords, description, pictures etc.). User A's client system (personal computers, laptop computers, tablet computers, smartphones etc.) communicates with the server system (WOK infrastructure) through connection 216, which represents a conventional cable or wireless connection. The WOK hosted on Data Server A accesses all WOK Windows contained in the infrastructure through connection A 211 via the internet 201 and searches all connected WOK Windows for the metadata that matches the searched content. The matching metadata is then presented to user A in the WOK's GUI in the user's web browser window 202.

FIG. 2. furthermore illustrates how, as in another embodiment of the present invention, technical devices 217 (sensors, machines etc.) that automatically generate data can also constitute or be integrated into the WOK infrastructure. Sensor X 217 represents a technical device which autonomously and automatically produces original data, for example, temperature data. By loading a WOK or part of a WOK on to the technical device, the device is capable of being programmed with the metadata describing its automatically produced content and presenting this metadata in the same way as a WOK Window on any other server. Similar to a Data Server, the technical device is connected to the internet 201 through a connection X 218 using conventional IT protocols (HTTP, TCP/IP etc.). The technical device is registered with the WOKs and uniquely identifiable through the technical device's IP address or other unique identifier. Data generated by a technical device within the WOS infrastructure are accessible in real time by all other servers and devices hosting the WOK within the infrastructure.

FIG. 2 furthermore illustrates how, as in another embodiment of the present invention, a technical device can also be accessed through the WOS infrastructure indirectly via a WOK Window on a Data Server. Connection Y1 219 represents a connection between the technical device and Data Server C 205 via the internet 201. Y2 220 represents a direct connection between the technical device and Data Server C 205. The automatically generated data from the technical device are transmitted either through connection Y1 219 or connection Y2 220 and stored on Data Server C 205 where WOK Window C 209 presents the corresponding metadata describing the automatically generated data from the technical device.

FIG. 2 furthermore illustrates how, as in another embodiment of the present invention, the technical device hosting WOK Window Sensor X 217 can also function as a transceiver if equipped with a port 221 to receive External Device Data 222 form connected technical devices. External Device Data is then received and metadata describing the External Device Data is transmitted and presented to the WOS infrastructure by the technical device Sensor X 217 either directly through WOK Window Sensor X 223 or indirectly via connection Y1 219 or Y2 220 through WOK Window C 209. For example, the External Device Data may be a chip card terminal with a slot for inserting chip cards for payment. A coffee machine may, for instance, be equipped with a slot to accept chip cards in which a user inserts their card to purchase coffee. The chip card utilizes the external port to exchange the purchase data with the WOK infrastructure where the purchase information is stored on the card itself and also communicated to the WOK infrastructure.

One skilled in the art will appreciate that the infrastructure can be used in various configurations where servers, technical devices and connections between them can be added, removed and rearranged. Similarly, users must not be directly connected to a server within the infrastructure but can also remotely connect to a server hosting the WOK through the internet.

FIG. 3 illustrates how metadata are presented in a WOK Window in one embodiment of the present invention. In A 301, a user provides the content and metadata via the WOK. The WOK then presents the metadata via WOK Window C 303. Because the WOK Window is connected to the internet 304 through a connection 305 using conventional HTTP, TCP/IP protocols, the data presented in the WOK Window is visible to the entire WOS infrastructure. Similarly, if a technical device automatically generates data as in B 302, it too is assigned metadata and presented in the WOK Window. Therefore, all metadata, weather it describes technical device data or human generated data, is accessible in the WOK Window.

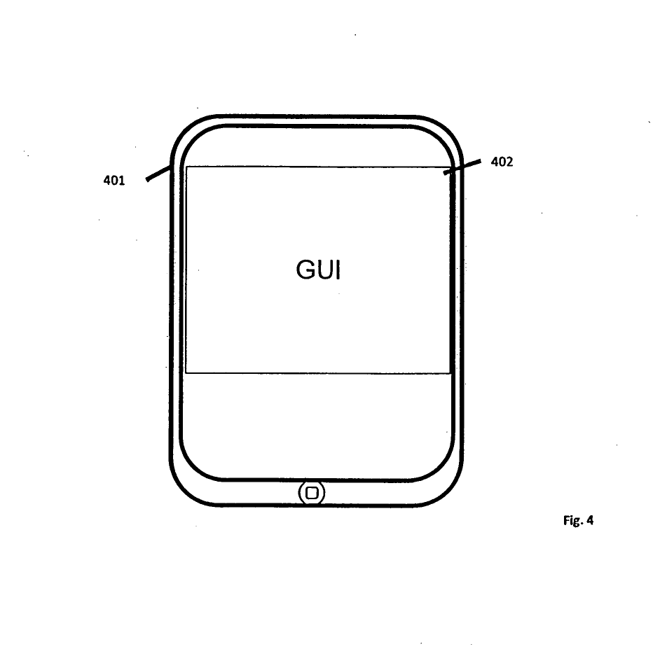

FIGS. 4-14 illustrate the use and operation of an example universal operating system software to organize data in the web in one embodiment of the present invention.

FIG. 4 illustrates client system 401 like a tablet PC displaying a web page presenting the example GUI 402 to control a WOK, through a conventional web browser window.

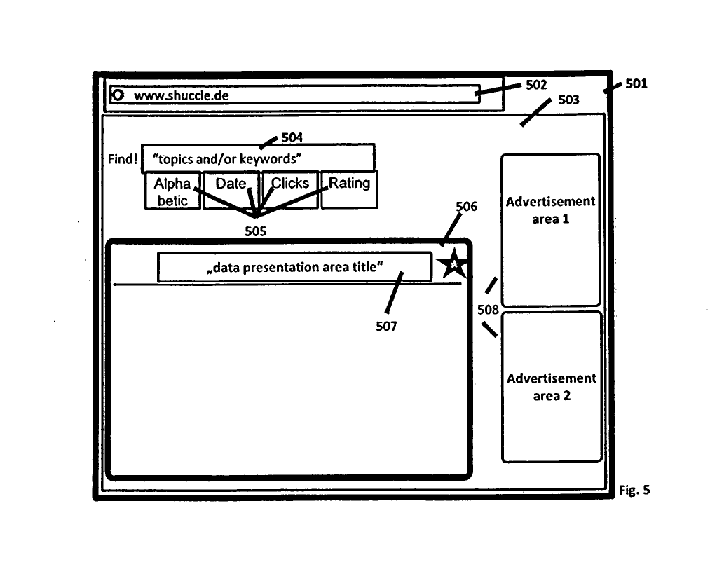

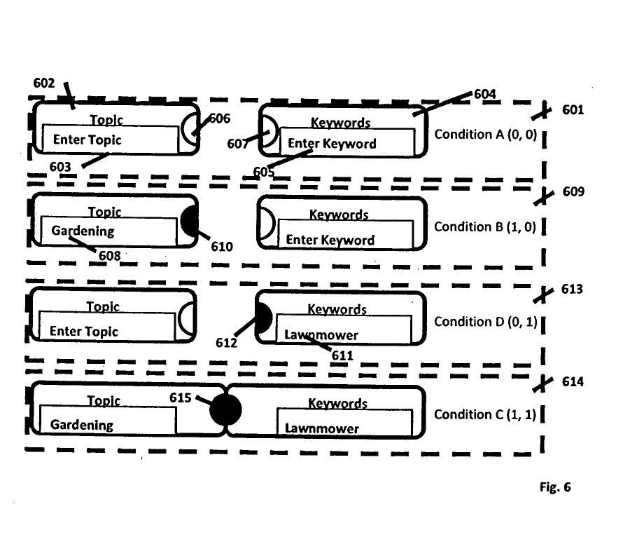

FIG. 5 represents the GUI 402 of FIG. 4 presented in a web browser window 501 containing an address bar 502, which is used to navigate to and open the web page by inputting the web page's URL. The browser window 501 displays an example web page 503 that presents the WOK's GUI containing a search and find window 504 in which the user enters search phrase to find content on the web. Search results can be sorted by criteria specified by the user (alphabetically, by date, most clicks or rating by other users etc.) by clicking the corresponding link button 505. Additionally, the GUI comprises customizable areas 508 (represented in the example web page of FIG. 5 by advertisement areas) that can be sold to thirds parties. The GUI also contains an area 506 that displays data and information to the user, in the following illustrations FIGS. 6-14, characterized by a pin wall like layout structure. Area 506 represented by FIGS. 6-14 is always identified by a descriptive title 507. The title 507 correlates with the phrase that appears in the search and find window 504. Similarly, if a user types in a search phrase, the descriptive title will correlate with the search phrase of the search and find window 504.

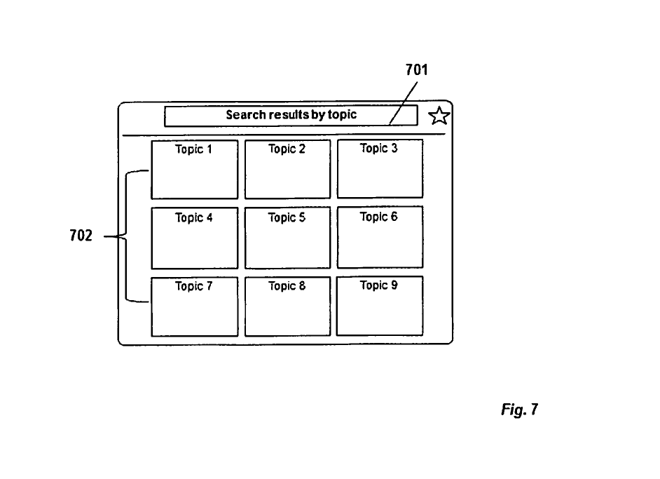

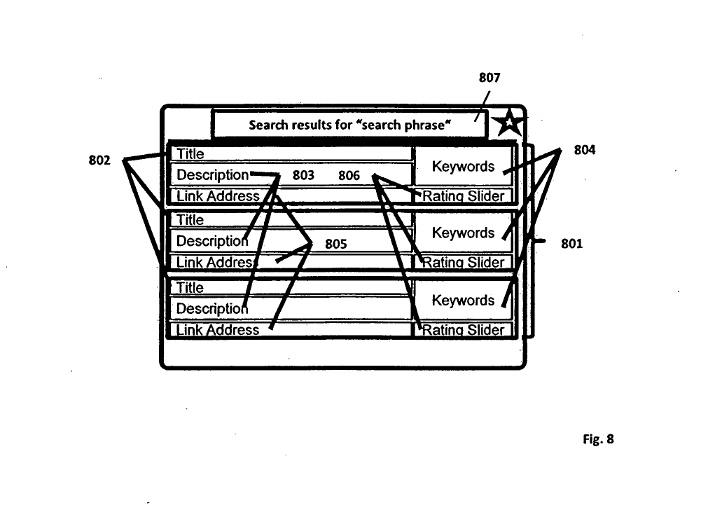

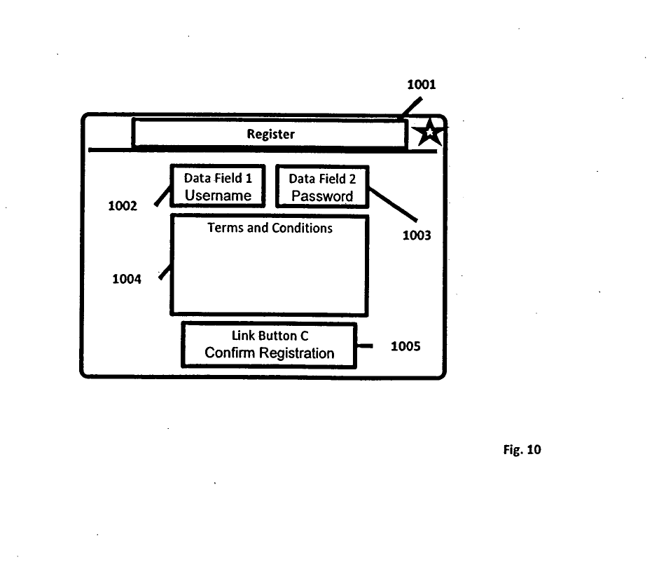

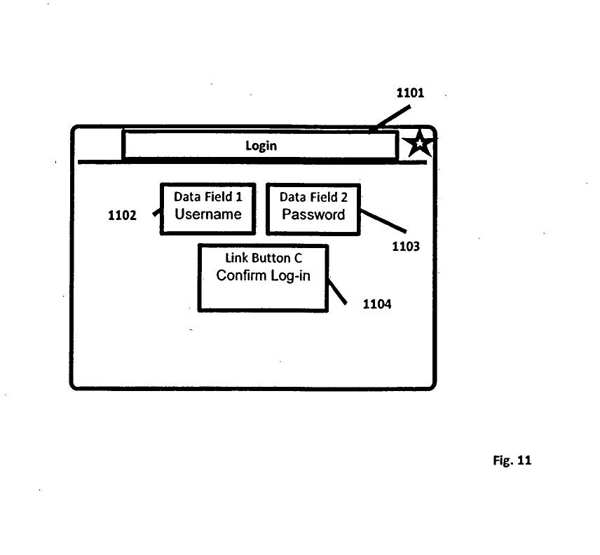

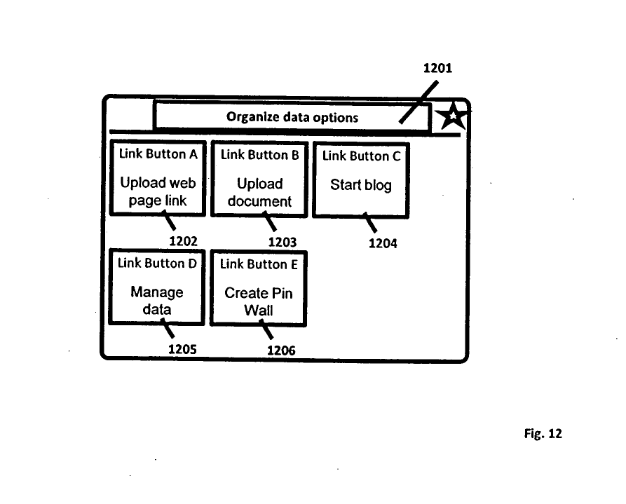

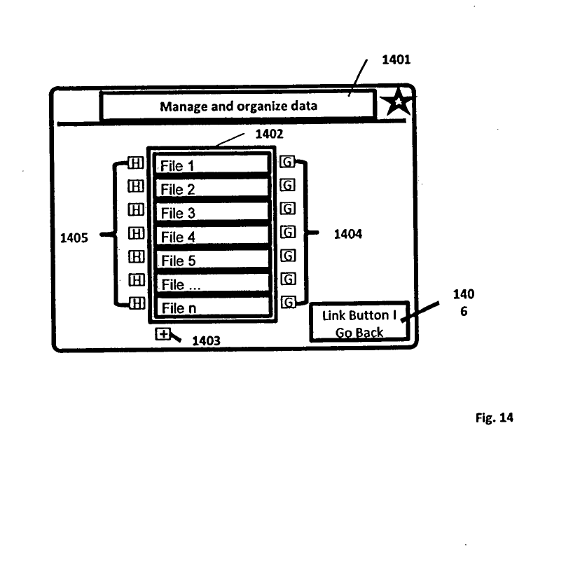

This data includes the relevant search results if a user initiates a search of content within the infrastructure (i.e., FIGS. 6, 7) or, if the URL of the WOK GUI's home page is called, options for the user to register and login (i.e., FIG. 8), login and registration data (i.e., FIGS. 9, 10), or, if the user is logged-in, links to the tools for the user to organize content in the web (i.e., FIGS. 11, 12, 13) as well as user specific content (i.e., FIG. 14).

FIG. 6 is an example illustration of how in one embodiment of the present invention the search and find window 504 of FIG. 5 may be represented by two separate windows to graphically illustrate how topic groups and keywords relate to each other as illustrated in condition A 601. One window is used to specify categorical topic groups while the other window is used for keyword searches. More specifically, window 602 is used to search within specific categorical topic groups and includes a textbox to enter the topic 603 while the window 604 is used to search for keywords and contains a textbox to enter the keyword or keywords 605. The graphic symbols 606, 607 exemplify what search specification a user requested. If, for instance, a user searches for content relating to lawnmowers, they may select the “gardening” topic group 608 as illustrated in condition B 609. The graphic symbol 610 indicates that the above mentioned topic group is selected for a search of the pertaining content. Similarly, a user may directly search for content relating to lawnmowers by entering the keyword “lawnmower” 611 without specifying a topic group. The graphic symbol 612 indicates that the keyword is selected for a search for content relating to lawnmowers in all topic groups as illustrated in condition C 613. Condition D 614 illustrates the case where a user specifies the topic group as well as the specific keyword “lawnmower”. The search results will return content relating to lawnmowers categorized under the gardening section. The graphic symbol 615 indicates that a user searched for a keyword within a specific topic group. A sequence of pictures 609, 613, 614 will appear to an observing user like a movement of two magnetic areas 610, 612 to each other which combine in on symbol 615. Combined with a sound the move effect may appear as it is like a physical magneto effect.

FIGS. 7, 8 illustrate example data presented in area 506 of FIG. 5 when a user initiates a search. A title 701 identifies the data currently presented. Because content within the infrastructure may be categorized by universal and sub topics, search results may be organized in topic groups. Links, presented as tiles 702, represent the topic groups for which the search phrase matches the metadata of original content. By initially selecting the appropriate umbrella topic group tile, the user is directed to a choice of sub topic group tiles. The user is thus able to narrow their search by navigating through the topic hierarchy. Once the most narrow topic hierarchy is reached, search results are displayed like in FIG. 8.

Alternatively, the GUI provides the option to present search results not organized by topics but directly in the list form as illustrated in the example in FIG. 8, presenting the search results where the search phrase matches all appropriate metadata within all topics groups. The example search results 801 displayed may comprise the metadata that correspond to the original content and may consist of a Title 802, a Description 803, a list of Keywords 804 that are used to describe the original data and Link Addresses 805 that link the metadata to the original content. Additionally, users may have the option to rate the usefulness and appropriateness of the metadata that was used to describe the original content through slide tool 806 on a scale of zero percent to 100 percent. The average of all ratings is displayed and visible to all users. A descriptive title 807 identifies the data currently presented.

FIG. 9 illustrates example data presented in area 506 of FIG. 5 when the URL of the WOK GUI's home page is called including a title 901, identifying the data currently presented, Link Button A 902, to register, and Link Button B 903, to log-in. In an embodiment of the present invention each user who organizes content in the web through the WOS infrastructure is uniquely identifiable by the WOK based on their registration information.

If Link Button A 902 is selected, the WOK will display a GUI like FIG. 5 where area 506 of FIG. 5 is displayed like FIG. 10 displaying a title 1001, identifying the data currently presented, Data Field 1 1002, prompting the user to provide a username, Data Field 2 1003, prompting the user to provide a password, and terms and conditions of use 1004 in addition to Link Button C 1005 to confirm the registration and acceptance of the terms and conditions. Upon completion of the registration the WOK will display a GUI like FIG. 5 where area 506 of FIG. 5 is displayed like FIG. 12.

If, alternatively, Link Button B 903 of FIG. 9 is selected, the WOK will display a GUI like FIG. 5 where area 506 is displayed like FIG. 11 displaying a title 1101, identifying the data currently presented, Data Field 1 1102, prompting the user to input the username, Data Field 2 1103, prompting the user to input the password, and Link Button C 1104 to confirm the log-in. Upon completion of the log-in the WOK will display a GUI like FIG. 5 where area 506 of FIG. 5 is displayed like FIG. 12.

FIGS. 12, 13, 14 illustrate example data presented in area 506 of FIG. 5 if a user is logged-in. If a user is logged-in, the WOK will display a GUI like FIG. 5 where area 506 is displayed like FIG. 12, presenting a title 1201, identifying the data currently presented, Link Button A 1202 to upload a web page link, Link Button B 1203 to upload documents or files (i.e. text files, Portable Document Format (PDF) files, video, graphic, music files, etc.) Link Button C 1204 to start a blog, Link Button D 1205 to manage data (delete, add or alter) specific to the user and Link Button E 1206 to create a pin wall (i.e. FIG. 5).

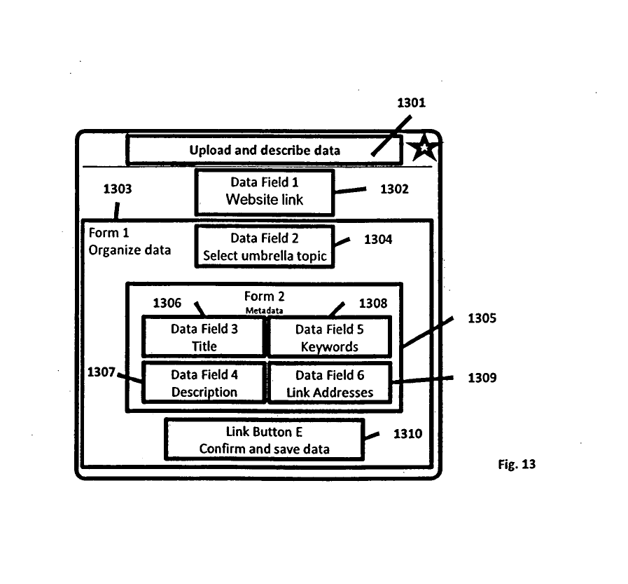

If Link Buttons A-C 1202, 1203, 1204 are selected, the WOK will display a GUI like FIG. 5 where area 506 of FIG. 5 is displayed like FIG. 13 presenting a title 1301, identifying the data currently presented, Data Field 1 1302, prompting the user to provide the location of the data to be uploaded, and Form 1 1303, including Data Field 2 1304, prompting the user to categorize the data by selecting an umbrella topic from a provided list, and Form 2 1305 to input metadata describing the original data consisting of a title, a description, keywords and link addresses. Form 2 1305 includes Data Field 3 1306 prompting the user to enter a title, Data Field 4 1307, prompting the user to enter a description, Data Field 5 1308, prompting the user to enter descriptive keywords and Data Field 6 1309, containing the automatically generated link by the WOK to the original data in addition to Link Button E 1310 to confirm and save the data on the server.

If, alternatively, Link Button D 1205 of FIG. 12 is selected, the WOK will display a GUI like FIG. 5 where area 506 of FIG. 5 is displayed like FIG. 14 presenting a title 1401, identifying the data currently presented, an overview of presently uploaded data 1402 and Link Button F 1403, to add, Link Buttons G 1404, to delete, Link Buttons H 1405, to edit data, and Link Button 11406 that, if selected, will prompt the WOK to display a GUI like FIG. 5 where area 506 of FIG. 5 is displayed like FIG. 12. While selecting any of Link Buttons G 1404 deletes the respective existing data and corresponding metadata from the server, selecting Link Button F 1403 will prompt the WOK to display a GUI like FIG. 5 where area 506 of FIG. 5 is displayed like FIG. 13. If Link Button H 1405 is selected, the same GUI is displayed as when Link Button F 1403 is selected but where the metadata to be edited is already presented in its respective fields.

If Link Button E 1206 of FIG. 12 is selected, the user is prompted to create a pin wall as described by and illustrated in FIG. 15.

In an embodiment of the present invention, a user can provide individualized data to be displayed within the GUI like FIG. 5 where area 506 of FIG. 5 is displayed like FIG. 15 in which the example layout is characterized as a pin wall that presents related data. A title 1501, which is also part of the metadata, identifies the pin wall and its content. In the Following example, travel agency “XYZ” may present the vacation packages they offer categorized under topic groups 1502 that may include adventure vacation, family holiday, weekend getaways etc.. If a user, looking to plan a vacation, selects a topic group, the WOK will display the respective topic group on a new pin wall that in turn may be organized into sub topic groups, which may include the location choices for the respective holiday packages (e.g. America, Europe, Asia, Africa and Australia). As the example illustrates, there is no limit to the sub topics, which are each represented by individual pin walls.

Since the pin walls themselves are organized into topic groups and described with metadata like a web page, as illustrated in FIG. 13, they are searchable within the WOS infrastructure like any other content. That is, both, the “main” pin wall of the travel agency itself as well as the individual pin walls containing the sub topic groups and individual vacation packages the agency offers will be directly found within the WOK infrastructure. Furthermore, because all data the travel agency provides on its pin walls are instantaneously stored within the WOK infrastructure, the data is immediately findable and available to all users. The delay of finding the data when using a conventional search engine is thus avoided.

The more relevant and appealing the content provided on the pin wall, the more users will visit the pin wall. Accordingly, the higher the clicks for a pin wall, the higher is its ranking. In an embodiment of the present invention, this ranking can be utilized to attract third party advertisers to purchase Advertisement Areas 1, 2 508 of FIG. 5 adjacent to the user's pin wall presented in area 506 of FIG. 5 from the user who created the pin wall directly. Because the provider of metadata and content is able to display advertisements that are relevant to the content they provide, they directly participates in the advertisement revenue. In the above mentioned case a third party may be any person or legal entity who wishes to advertise. The advertiser may directly purchase the advertisement space from the content provider, in this case the second party while the first party constitutes the WOK system provider.

One skilled in the art will appreciate that the various sections of the GUI can be omitted, adapted or rearranged in various ways. In general, the GUI must contain only a search bar or similar tool to enter keyword(s) or search phrase(s), an area in which the search results are displayed, links to the tools that allow users to organize data in the web and an area in which personalized and user specific data content uploaded by the user can be displayed in addition to customizable areas that can be sold to third parties.

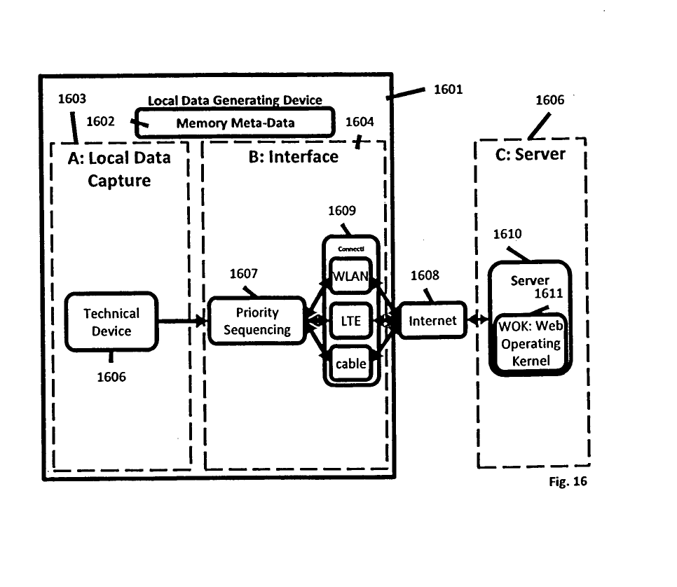

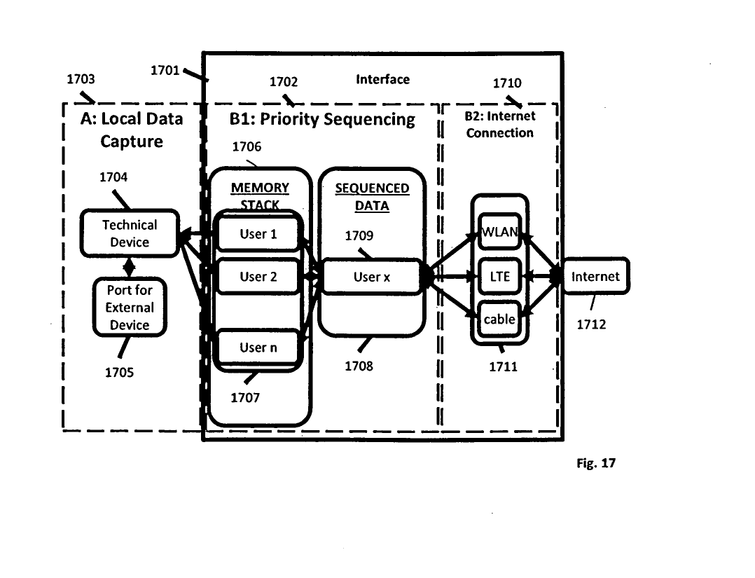

An embodiment of the present invention governs the priority sequence of data exchanges between a server and multiple clients within the WOS infrastructure. More particularly, the priority sequencing mechanism is software, which is embedded in the WOK, that controls the flow of data from the data generating source to the individual users. Because of bandwidth limitations arising from a high number of users requesting to access data simultaneously or by users requesting a large quantity of data, not all users can receive the requested data concurrently. The priority sequencing component of the present invention ensures that each individual user receives a complete set of the requested data. FIGS. 16, 17 illustrate an example flow of data from a technical device to the individual user through priority sequencing.

FIG. 16 illustrates an example overview of data flow from a Local Data Generating Device 1601, to a server hosting the WOK. The Local Data Generating Device includes a Memory Meta-Data 1602 which stores metadata identifying the device and its data, a Local Data Capture 1603 component, which may constitute a sensor or other technical device, and an interface 1604 to sequence and communicate the device's data via the internet. The data flow process can be divided into three distinct stages: A: Local Data Capture 1603 B: Interface 1604 and C: Server 1605. In stage A 1603, data is generated by a technical device 1606, such as a sensor (i.e., FIG. 17). In stage B 1604, the data is prioritized through a priority sequencing component 1607 and transmitted via the internet 1608 through conventional wired or wireless connections 1609. In stage C 1605 the data is stored on a Server 1610 hosting the WOK 1611, through which the user can access the requested data.

One skilled in the art will appreciate that the various components can be omitted, adapted or rearranged in various ways and that the Local Data Capture component 1603 of FIG. 16 may include external ports through which the device communicates data from externally connected devices.

FIG. 17 is a detailed example illustration of stages A 1603 through B 1604 of FIG. 16. FIG. 17 illustrates an example flow of data through the Local Data Generating Device's interface 1701 component including the prioritization sequencing 1702 before being transmitted to the user via the internet. The data flow process can be divided into three distinct stages: A: Local Data Capture 1703 where a technical device 1704, such as a sensor, automatically produces data or, where it acts as a transceiver, transmits data through an external port 1705. B1: Priority Sequencing 1702, the data are transmitted to an intermediate memory. The priority sequencing component entails a memory stack 1706, which is partitioned into user stacks 1707 that are respectively assigned to each user currently requesting data from the technical device. Data requested by the specific user is stored in the respective partition. In the sequenced data component 1708, the data corresponding to the user 1709 first in sequence is selected from the respective memory stack. In Step B2: Internet Connection 1710, the data requested by the user is transmitted through wired or wireless connections 1711 using conventional IT protocols (HTTP, TCP/IP etc.) via the internet 1712.

The scope of the present invention is defined by the claims that follow.

1. A devise and method for establishing an infrastructure in the internet for providing and organizing technical and human generated data which is presented as Web-Content and accessible by WEB-Methods comprising:
a Web-Operation-Kernel WOK consisting of a software and a data memory which both are loaded on different local servers,
the unique Internet-Addresses of the local servers containing the WOKs are stored on each of the distributed WOKs for exchanging WOK-Data,
the WOK-Data contain metadata which are set by users via a browser, the metadata are structured in different classes for describing technical or human generated data,
one class is used for presenting advertising data,
the WOK-Data and tools are presented in WOK-Windows in browsers and are accessible by their unique address through interne methods,
each WOK on a server has instantaneous access to the metadata of each other WOK through their known addresses,
As such, an infrastructure is established which presents human generated metadata that refers to technical or human generated original data and in which the metadata are instantaneously accessible.

2. A device and method of claim 1
wherein the WOK is located on specific server hardware in a server farm environment.

3. A device and method of claim 1
wherein one WOK constitutes the original main WOK on which all other remote WOKs on the different dispersed local servers depend for the organization of their data memory and software.

4. A device and method of claim 2
wherein each of the WOKs on the different local servers is identified by a specific name or number or graphic or symbol or IP address.

5. A device and method of claim 1
wherein the WOK-Data memory is organized by a database which is structured to contain the different classes of the metadata.

6. A device and method of claim 3
which includes means for structuring the memory of the original WOK into categorical groups,
whereby the categorical groups are predefined topic groups which specify aspects of metadata,
whereby the category groups are managed on the original main WOK from where they are communicated and transferred to all other WOKs on the local servers,
so that Web-Content and metadata on each local server may be classified by and assigned to category groups.

7. A device and method of claim 1
wherein the WOK-Window is presented in a browser window.

8. A device and method of claim 1
that includes means for inputting a search term in the WOK-Window, which is used as a query for instantaneously finding metadata stored within the infrastructure of the WOKs and their topic groups.

9. A device and method of claim 1
that includes means for inputting a search term and a name of a category group in two separated windows in the WOK- Window,
whereby the separated windows move in a visible effect to each other in case that the search term and the categorical group are assigned to metadata.

10. A device and method of claim 1
wherein the tools include means for users to provide web content which includes webpages, blogs and any files with internet compatible file formats.

11. A device and method of claim 1
wherein the advertising areas can be rented by third parties.

12. A device and method of claim 1
wherein the technical data are generated by a Local-Data-Generating-Device and presented instantaneously and concurrently to multiple requesting users through the internet.

13. A device and method of claim 9
wherein the Local-Data-Generating-Device contains the parts Memory-Meta-Data, Local-Data-Capture, Interface,
wherein the interface contains the parts Priority-Sequencing and an Internet-Connection.

14. A device and method of claim 10
wherein the Memory-Meta-Data contains the meta data which are set by users for describing the Local Data Generating Device and its data.

15. A device and method of claim 10
wherein the Memory-Meta-Data contains specific inerasable data for uniquely identifying the Local-Data-Generating-Device.

16. A device and method of claim 10
wherein the part Local-Data-Capture constitutes the technical device which produces technical data.

17. A device and method of claim 11
wherein the Local-Data-Capture contains one or more ports for exchanging data with externally connected devices.

18. A device and method of claim 11
wherein the Priority-Sequencing contains the part Memory-Stack and Sequenced-Data.

19. A device and method of claim 11
wherein the Memory-Stack is a partitioned memory in which individual partitions are assigned to each individual user that requests data from the Data-Generating-Device,
whereby each requesting user receives the complete data generated by the Local-Data-Capture.

20. A device and method of claim 14
wherein the port for exchanging data with externally connected devices is equipped to accept data from transportable data devices.
